(19) United States
(12) Patent Application Publication
(10) Pub. No.: US 2005/0155621 A1
(43) Pub. Date: Jul. 21, 2005

(54) Case with integrated closer

(76) Inventor: Robert Petit, Cluny (FR)

Correspondence Address: YOUNG & THOMPSON, 745 SOUTH 23RD STREET, 2ND FLOOR, ARLINGTON, VA, 22202, US

(21) Appl. No.: 11/029,543

(22) Filed: Jan. 6, 2005

(30) Foreign Application Priority Data
Jan. 19, 2004 (FR) 04 00436

(51) Int. Cl. H01P 1/20

(52) U.S. Cl. 132/316

(57) ABSTRACT

The case (1) comprises a cover (2) provided with a first hinge element (20) and a bottom (3) provided with a second hinge element (30), a hinge (4) being formed by cooperation between the said first (20) and second (30) hinge elements, a closer (5) comprising cooperation of a first closer element (21) fixed to the said cover (2), and a second closer element (31) fixed to the said bottom (3). This case is characterised in that:
a) the said bottom (3) includes a peripheral border (32) provided with an outer skirt 320) having a discontinuity, so as to form a recessed outer part (321),
b) the said bottom (3) comprises a front part (34) fixed to the said lip (310), the said front part (34) being placed in the said recessed part (321) so as to be free to move with respect to the said outer skirt (320),
c) the said front part (34) forms a single-piece part with the said bottom (3) or with the said inner frame (3′), due to a solidarisation means,
d) the said solidarisation means forms or includes a springback means, such that the said second closer element (31) fixed to the said front part (34) has a lateral displacement latitude, and thus allows reversible cooperation with the said first closer element (21). Advantages: possibility of making a case with a limited number of easily assembled parts.

### SCOPE OF THE INVENTION

The invention relates to the domain of cases designed to contain cosmetic products or beauty products, typically makeup powders.

### STATE OF THE ART

In general, cases typically comprise:
a recessed cover provided with an internal mirror,
a recessed bottom, typically provided with an inner frame or intermediate support of at least one receptacle in which the said cosmetic product will be placed,
a hinge, forming the connecting device between the said cover and the said bottom, used for articulation of the said cover and opening of the said case,
a closer or any means of locking and unlocking the said cover with respect to the said bottom, so as to open and close the said case, a typical closer being a push button.

Many different embodiments of cases are known, that may apply to one or several constituents of the case.

Thus, patents issued in the name of the applicant include:
patent FR 2 661 080 that describes a compact makeup case with a closer,
patent FR 2 701 365 that describes a transformable makeup case,
patent FR 2 725 958 that applies to a case with a flush fitting closer with assisted opening,
patent FR 2 737 192 that describes a case with a pivoting cover provided with a hinge and flexible tabs,
patent FR 2 755 352 that describes a case with assisted opening,
patent FR 2 755 353 that describes a case with an unlocking and pre-opening pushbutton,
patent FR 2 756 155 that describes a makeup case, of the type comprising a bottom, an intermediate tray and a cover provided with an internal mirror,
patent EP 0 467 761 that describes a case provided with a single piece closer.

### PROBLEMS THAT ARISE

The invention is firstly intended to form a case comprising a limited number of moulded parts, typically two moulded parts, namely a bottom and a cover, such that it is particularly easy and economic to assemble the different parts of the case.

The invention is also intended to form a case which is just as easy to open and manipulate as a traditional case.

The invention is also intended to form a very esthetic case, particularly a case with a regular and uniform sidewall.

Accessorily, the invention is also intended to obtain moulded parts that are economic in themselves.

### DESCRIPTION OF THE INVENTION

The case according to the invention is designed for packaging of cosmetic products, and includes a cover typically provided with a mirror and with a first hinge element and a bottom, possibly including an inner frame fixed to the said bottom, forming a cavity that contains the said cosmetic product or a receptacle containing the said cosmetic product, the said bottom or the said inner frame being provided with a second hinge element, a hinge being formed by cooperation between the said first and second hinge elements so as to enable the cover to rotate with respect to the said bottom about a rotation axis, a closer or any means of locking and unlocking the said cover with respect to the said bottom or the said inner frame, typically comprising cooperation of a first closer element, typically a locking hook fixed to the said cover, and a second closer element fixed to the said bottom or the said inner frame, and typically comprising a lip that will cooperate with the said hook, the said closer or the said second closer element typically being activated by a push button, the said case possibly including an applicator of the said cosmetic product.

This case is characterised in that:
a) the said bottom includes a peripheral border provided with a typically straight outer skirt, the said outer skirt typically having a discontinuity on all or some of its height H and along a peripheral length L on its front part, so as to form a recessed outer part,
b) the said bottom comprises a front part fixed to the said lip, the said front part being placed in the said recessed part and separated from the said outer skirt typically by two side axial recesses with spacing E typically less than 1 mm, so as to be free to move with respect to the said outer skirt,
c) the said front part forms a single-piece part with the said bottom or with the said inner frame, due to a solidarisation means,
d) the said solidarisation means forms or includes a springback means, such that the said lip fixed to the said front part which is typically rigid, has a lateral displacement latitude, typically by translation and/or rotation, and thus forms reversible cooperation with the said hook, and that the said second closer element forms a single piece part with the said bottom or the said inner frame, typically made of a thermoplastic material.

This combination of means provides a means of solving the problems that arise.

In the case according to the invention, the closer and more particularly the said second closer element, in other words the part of the closer fixed to the bottom or to the inner frame, does not in itself require any added parts, as is normally the case to obtain reliable closing and easy opening of the case.

Thus, the said front part which is completely fixed to the bottom or the inner frame on one side, and is fixed to the locking lip on the other side, forms a part of the second closer element, which is visible from the outside and is perfectly integrated into the outer skirt of the bottom, such that highly aesthetic cases are obtained, the closer mechanism thus being either invisible or at least only slightly visible as such.

### DESCRIPTION OF THE FIGURES

All figures relate to a case (1) according to the invention.

FIGS. 1a to 3f relate to the bottom (3) of this case.

FIG. 1a is a perspective view of the side and the top.

FIG. 1b is a top view.

FIG. 1c is a bottom view.

FIG. 1d is a partial bottom view corresponding to the part surrounded by a rectangle in FIG. 1c.

FIG. 2a is a sectional view at the vertical plane A-A in FIG. 1b.

FIG. 2b is an enlarged view of the front part of the bottom (3), and particularly the second closer element (31) corresponding to the left part surrounded by a circle in FIG. 2a.

FIG. 2c is an enlarged view of the back part of the bottom (3) of FIG. 2a, and particularly the second hinge element (30) corresponding to the right part surrounded by a circle in FIG. 2a. This view corresponds to a sectional view at a vertical median plane perpendicular to the axis (40) of the hinge (4).

FIG. 2d is a sectional view at the vertical plane D-D in FIG. 1b.

FIG. 2e is a front view.

FIG. 2f is a side view.

FIG. 2g is a back view.

FIG. 3 is a top view corresponding to the part shown in FIG. 1d (as a bottom view).

FIGS. 3a to 3f are sections at vertical planes a-a to f-f respectively in FIG. 3.

FIGS. 4a to 4h relate to the cover (2) of the case (1).

FIG. 4a is a perspective view.

FIG. 4b is a top view.

FIG. 4c is a bottom view.

FIG. 4d is a sectional view at the vertical plane D-D in FIG. 4c.

FIG. 4e is an enlarged view of the left part of FIG. 4d, corresponding particularly to the said first closer element (21).

FIG. 4f is an enlarged view of the right part of the FIG. 4d, particularly corresponding to the said first hinge element (20).

FIG. 4g is a side view.

FIG. 4h is a back view.

FIGS. 5a to 5i relate to the closed case (1) formed from the bottom (3) according to FIGS. 1a to 3f, and the cover (2) according to FIGS. 4a to 4h.

FIG. 5a is a front, side and top perspective view.

FIG. 5b is a side view.

FIG. 5c is a back view.

FIG. 5d is a top view.

FIG. 5e is a front view.

FIG. 5f is a bottom view.

FIG. 5g is a section at the vertical plane A-A in FIG. 5e.

FIG. 5h is an enlarged view of the left part of FIG. 5g, particularly corresponding to the closer (5).

FIG. 5i is an enlarged view of the right part of FIG. 5g, particularly corresponding to the hinge (4).

FIGS. 6, 7a and 7b illustrate an example showing the manufacturing method of the bottom (3), and more particularly the said second closer element (31).

FIG. 6 represents the said second closer element, and corresponds to FIG. 3f.

FIG. 7a represents the portion of the said lower part (61) of the manufacturing mould (6) of the second closer element (31) in FIG. 6.

FIG. 7b represents the portion of the said upper part (60) of the manufacturing mould (6) of the second closer element (31) in FIG. 6.

FIGS. 8 and 8a to 8f corresponding to FIGS. 3 and 3a to 3f, illustrate another embodiment of the invention.

FIGS. 9 and 9a to 9f corresponding to FIGS. 3 and 3a to 3f, illustrate another embodiment of the invention according to FIGS. 3 and 3a to 3f.

### DETAILED DESCRIPTION OF THE INVENTION

According to the invention, the said lateral displacement of the said lip (310) may be achieved by applying manual pressure on the said cover (2), the said bottom (3) being held fixed.

The said lateral displacement of the said lip may also be achieved by applying manual pressure on the said front part (34) acting as a push button (50).

In the first case, the manual pressure applied on the cover is sufficient to overcome the click fit force of the locking lip (310) fixed to the bottom or the inner frame and the locking hook (210) fixed to the cover.

In the second case, manual pressure applied on the said front part (34) moves the said locking lip (310), typically in translation, relative to the said locking hook (210), and thus unlocks the closer (5) of the case (1).

Typically, the said front part (34) may be a rigid part, the said lip (310) typically also being rigid, such that any movement of the said front part (34), no matter how small, is transmitted to the said lip (310), in order to unlock the said closer (5).

An overlap between the said lip (310) and the said hook (210) of the order of 0.5 mm, typically 0.4 to 1 mm, may be sufficient to close the cover.

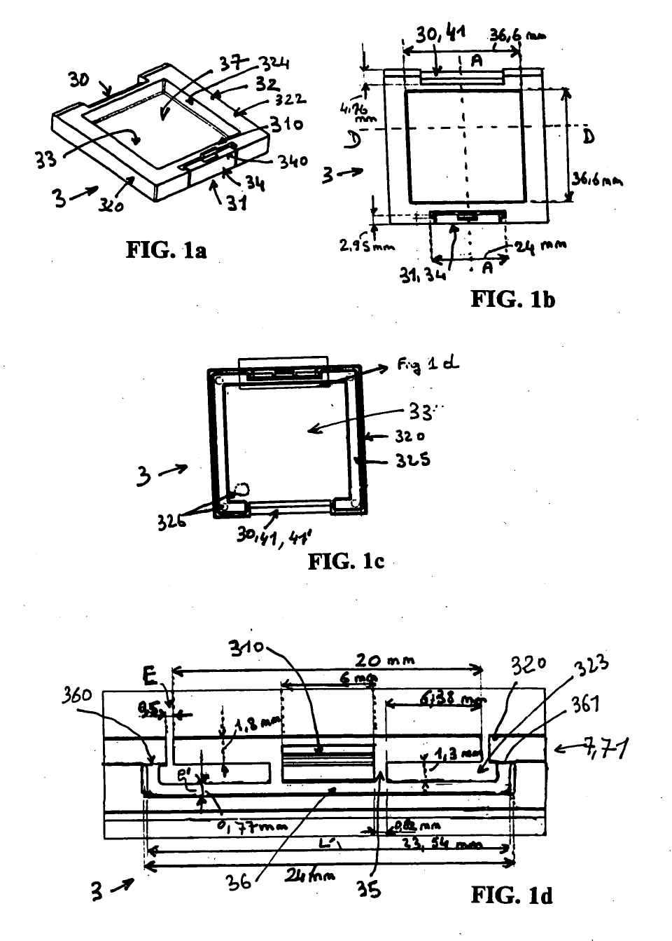

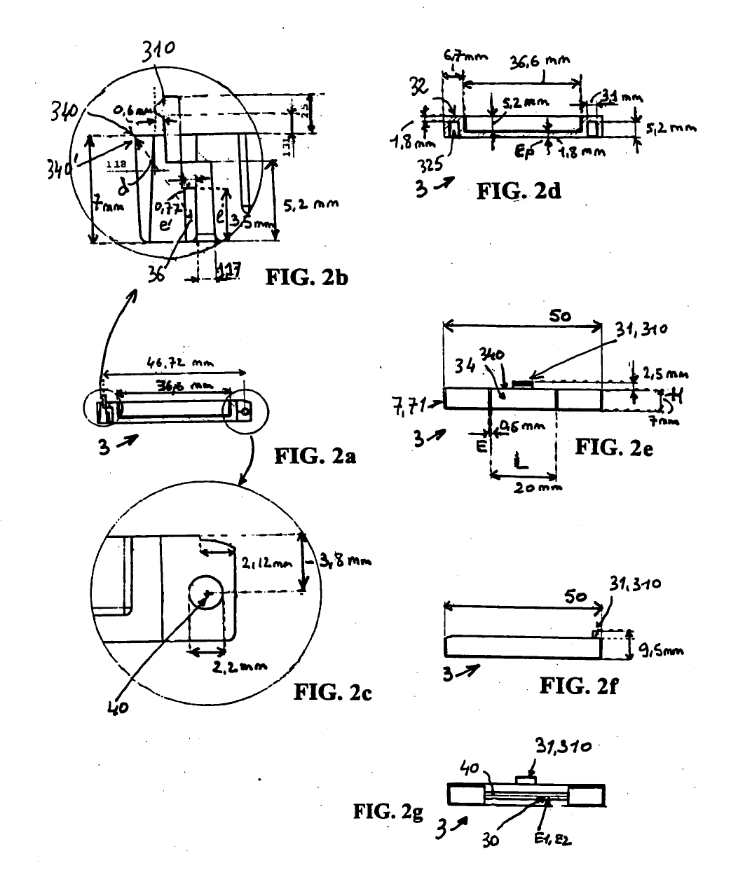

As can be seen for example in FIGS. 1a and 2e, the said front part (34) may have the said height H, such that the said front part (34) has an upper border (340) flush with the top surface of the said peripheral border (32).

Similarly, the said front part (34) may have a vertical cross section typically similar to that of the said recessed outer part (321) so that it is inserted in the said recessed external part (321), and an external surface typically forming an extension of the said outer skirt (320) such that the shape and surface of the said front part (34) are continuous with the shape and surface of the said outer skirt (320).

However, the said front part (34) may have an external surface or an appearance that is visually distinct from the said surrounding peripheral border, for example an external surface projecting from or set back from the outer skirt (320) of the peripheral border (32), in order to indicate the position on the closer (5) at which manual pressure should be applied, if it is necessary.

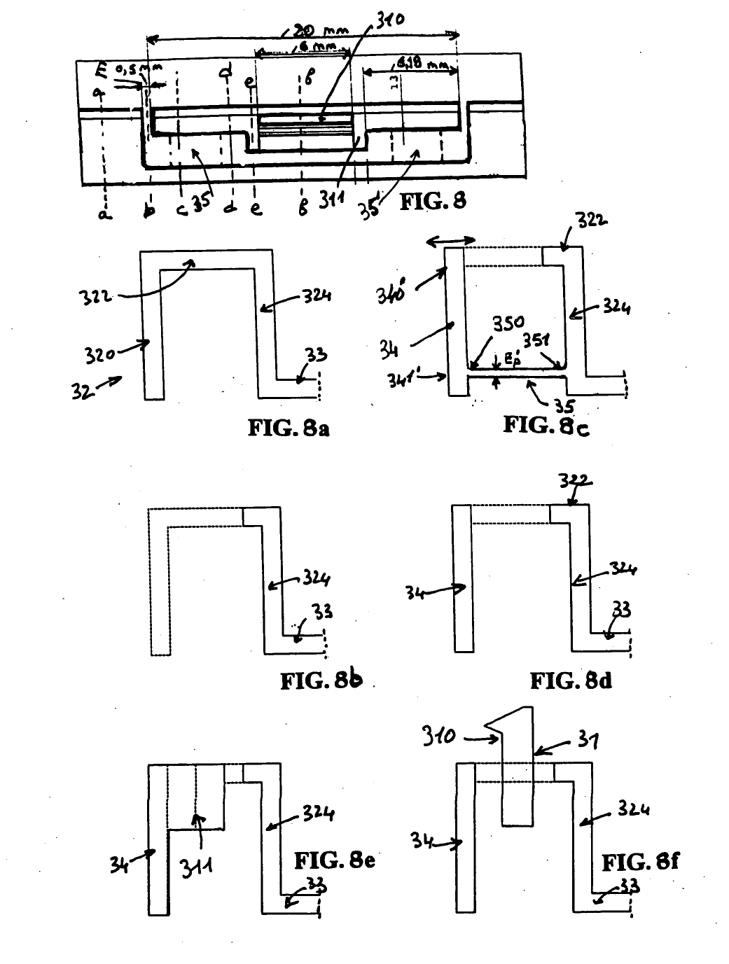

According to the invention, and according to one embodiment of the invention as illustrated in FIGS. 8 and 8a to 8f, the said solidarisation means may include at least one spacer (35) fixed to the lower part (341′) of the said front part (34) through its front junction (350), and typically arranged to be perpendicular to the said front part (34), such that the said lateral displacement may typically include a rotation of the said front part (34) when the said manual pressure is applied on an upper part (340′) of the said front part (34), as illustrated in FIG. 8c.

The said spacer (35) may be fixed to the said bottom (3) or the said inner frame (3′) through its rear junction (351), the dimensions of the said spacer (35) being chosen to achieve the said rotation and the said springback.

According to another embodiment of the invention illustrated particularly in FIGS. 1a to 7b, the said spacer (35) may be solidarised, through its rear junction (351), to a transverse tab (36) typically parallel to the said front part (34), comprising ends (360, 361) fixed to the said bottom (3) or the said inner frame (3′), with dimensions and particularly length L′, width l′ and thickness e′ chosen so as to enable translation and/or rotation of the said front part (34) and the said springback, the said transverse tab (36) typically forming a torsion and/or bending beam fixed through its two ends to the said bottom or the said inner frame, and fixed through its centre to the said front part (34).

Typically, the said length L′ may be equal to at least the said length L, the said length L′ being the distance separating the said ends (360, 361).

Depending on the type of case and its external dimensions, the said length L′ may vary from 15 mm to 40 mm, and typically from 20 mm to 30 mm.

The width 1′ may typically vary from 1 to 5 mm, the thickness e′ typically varying from 0.3 mm to 1.5 mm.

The value of L′, l′ and e′ are chosen such that the beam formed by the said transverse tab (36) causes a resilient torsion and/or bending, following manual pressure applied to the said front part (34) in order to open the case, and typically on its upper part (340′).

The ratio between the length L′ and the section of the beam (l′xe′) in the bottom (3) of the case as shown in FIGS. 1a to 2g is approximately 8.7 mm⁻¹. If the L′/l′.e′ ratio is smaller, which is typically achieved by increasing e′, the manual force to be applied will be larger, while the inverse will be true if the ratio is larger.

The ratio L′/l′.e′ may typically be between 5 and 15, and preferably between 7 and 10.

Advantageously, as illustrated in FIG. 2b, the distance d between the said upper part (340′) of the said front part (34) and the said transverse tab (36) may be such that the d/l′ ratio is equal to at least 1 and preferably at least 1.5, so that the torque is sufficient to facilitate torsion of the said transverse tab (36) under manual pressure.

This distance d corresponds approximately to the distance between the upper border (340) of the said front part (34) and the geometric centre of a cross section of the said transverse tab (36). This distance d is 6 mm on the bottom (3) of FIG. 2b, and in this case the d/l′ ratio is equal to 1.7.

According to the invention, and as illustrated on all figures related to the bottoms (3) of the case (1), the said front part (34) may be fixed to the said bottom (3), the said front part (34) and the said bottom (3) forming the said single piece part (7,71).

As illustrated particularly in FIG. 1a, the said peripheral border (32) of the said bottom (3) may include a typically plane upper edge (322) fixed to the said outer skirt (320), the said upper edge (322) comprising a recessed part (323), so as in particular to displace the said front part (34) and to displace the said locking lip (310) in order to open the case, the said front part (34) being aligned, on the outside, with the said peripheral border (32) and more precisely with the said outer skirt (320) and with the said upper edge (322).

Most frequently, and as illustrated in FIGS. 1a, 2a and 2d, the said peripheral border (32) may comprise an inner skirt (324) fixed to the said plane upper edge (322), the said outer skirt (320), the said plane upper edge (322) and the said inner skirt (324) forming a peripheral cavity (325) with an inverted “U” profile on all or some of the case, typically on the sides and on a front part of the case, as can be seen in FIG. 2d.

The said bottom (3) may comprise a lower panel (33) fixed to the said inner skirt (324) so as to form the said central cavity (37) in the case in which the said bottom (3) is not provided with an inner frame (3′), the said central cavity (37) having a depth H−Ep, where Ep is the thickness of the said lower panel (33) as illustrated in FIGS. 2d and e.

Advantageously, the said hinge (4) may be formed by cooperation of at least one male element (41) with at least one female element (42), the said female element (42) forming a hub with a lateral axial opening with springback (420), such that the said hinge (4) may be formed by click fitting of the said male element (41) and female element (42).

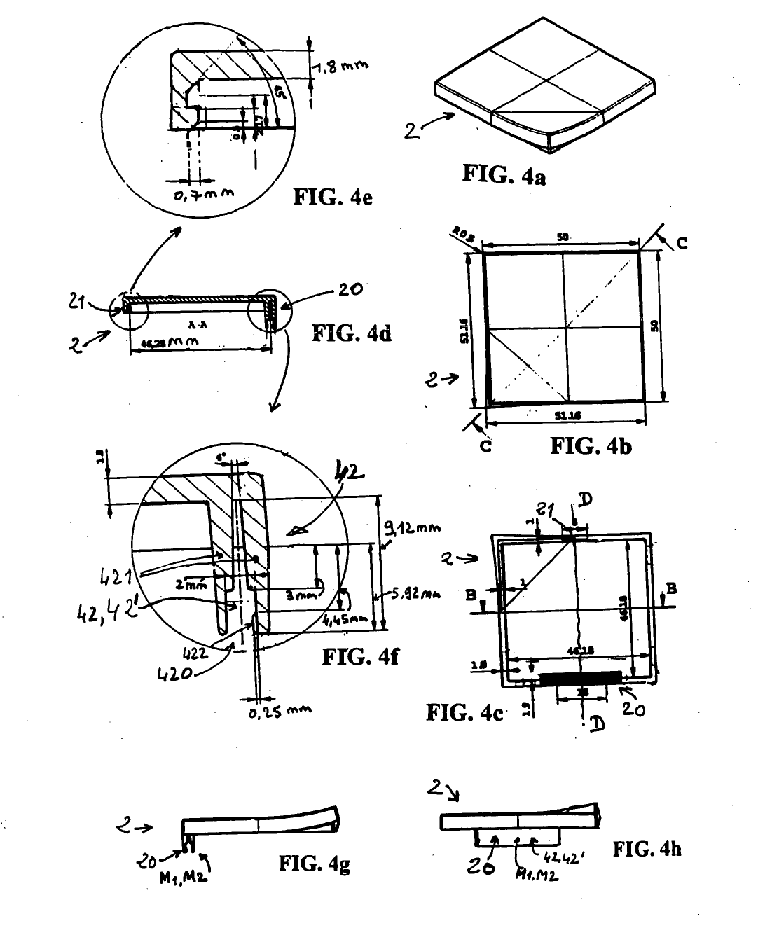

As illustrated in FIG. 4f, the said female element (42) may comprise two wall elements facing each other and parallel to each other (421) that may be moved elastically apart during the said click fitting, and with an axial recess forming the said hub.

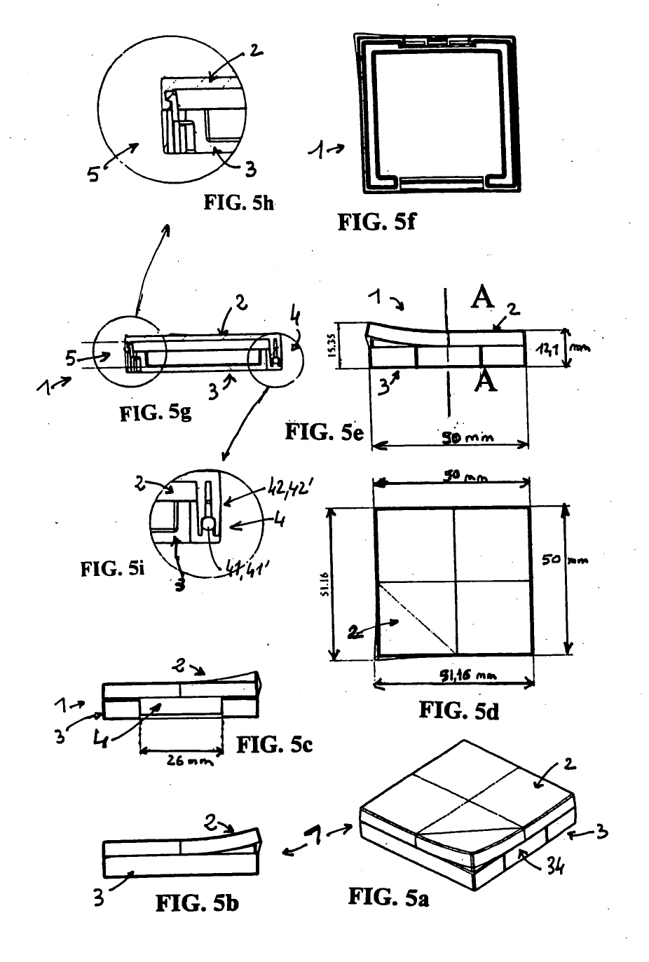

According to one embodiment of the invention illustrated in FIGS. 5g and 5i, the said first hinge element (30) carried by the said cover (2) may include the said female element (42), the said second hinge element (30) carried by the said bottom (3) including the said male element (41).

But according to the invention, it would be possible to have a case in which the said second hinge element (30) carried by the said bottom (3) would include the said female element (42), the said first hinge element (20) carried by the said cover (2) then including the said male element (41).

The said female element (42) may form or include one or two hubs M1, M2 (42′), the said male element (41) forming or including one or two spindles E1, E2 (41′), the said hinge (4) comprising a central hinge or two half-hinges, a right half-hinge, and a left half-hinge, each half-hinge being formed by cooperation of a hub M1, M2 (42′) and a corresponding spindle E1, E2 (41′).

FIGS. 2c, 2g, 4h, 4f, 5c illustrate the case in which the case (1) comprises a central hinge, the hinge (4) of the case (1) as shown in FIGS. 5a to 5i being formed by cooperation of a central hub (42′) carried by the cover (2) with a central spindle (41′) carried by the bottom (3).

But according to another embodiment of the hinge (4), the said female element (42) may form or may include two distinct hubs M1 and M2 (42′), the said male element (41) forming or comprising one or two distinct spindles E1 and E2 (41′).

According to a first variant of this embodiment, the two hubs M1 and M2 may form the outside of the said hinge (4) and the two spindles E1 and E2 may form the inside of the said hinge (4), the said hinge (4) then forming a sequence denoted “M1-E1-E2-M2”.

According to a second variant of this embodiment, the two hubs M1 and M2 may form the inside of the said hinge (4) and the two spindles E1 and E2 may form the outside of the said hinge (4), the said hinge (4) then forming a sequence denoted “E1-M1-M2-E2”.

Advantageously, and as is the case with the case (1) according to FIGS. 5a to 5i, the said hinge (4) may be formed by click fitting, typically in the axial direction, of the said first (20) and second (30) hinge elements, the said bottom (3) typically without the said inner frame (3′) forming the said central cavity (37).

The said click fitting of the bottom (3) and the cover (2) directly forms the case (1)—typically closed.

According to the invention, the said thermoplastic material forming the said cover (2) may be a typically transparent thermoplastic material, the said bottom (3) being formed from a transparent thermoplastic material or a non-transparent plastic material, containing a typically pigmented colouring material.

When the said cover (2) is made of a transparent plastic material, it does not usually include a mirror, so that the contents of the case (1) can be seen without needing to open it. However, and conversely, if the cover (2) is made of a non-transparent plastic material, it may typically include an internal mirror.

Advantageously, the said thermoplastic moulded part forming the said moulded single piece part (7) may be made of a so-called “rigid” thermoplastic material with a bending modulus equal to at least 2000 MPa, typically chosen from among SAN or PS.

According to the invention, the said front part (34) forming part of the said closer (5) may be straight or curved, depending on the shape of the said case (1) that may be polygonal and typically square or rectangular, or round, or oval. The invention is not limited to a particular shape of the case (1).

Another purpose of the invention consists of a manufacturing method for a case (1) according to the invention.

In this method, the said bottom (3) and/or the said cover (2) may be formed by moulding a thermoplastic material in a mould (6) typically in two parts, an upper part (60) and a lower part (61) that cooperate by axial displacement to form an inner cavity (62) corresponding to the said bottom (3) or the said cover (2) and supplied with thermoplastic material through at least one duct, all parts of the said cavity and therefore all parts of the said bottom (3) or the said cover (2) possibly being formed or delimited by one or several axial elements (600, 610) of the said upper part (6) and/or the said lower part (61), such that the said mould (60) can be closed and then opened by a simple single relative directional axial displacement of the said upper part (60) and lower part (61), and that the said bottom (3) or the said cover (2) can then be extracted from the said open mould.

Note that the bottom (3), together with its front part (34) forms the said moulded single piece part (7) including the said solidarisation means.

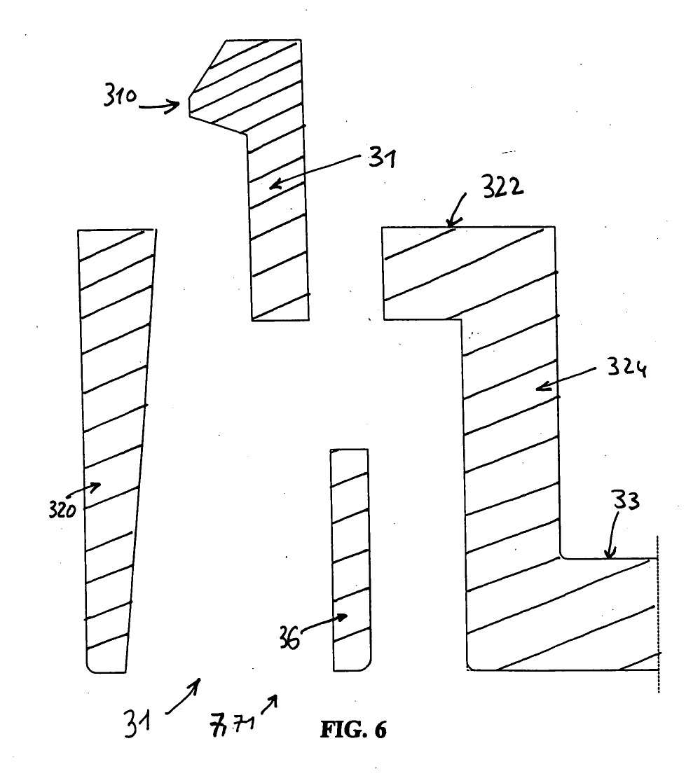

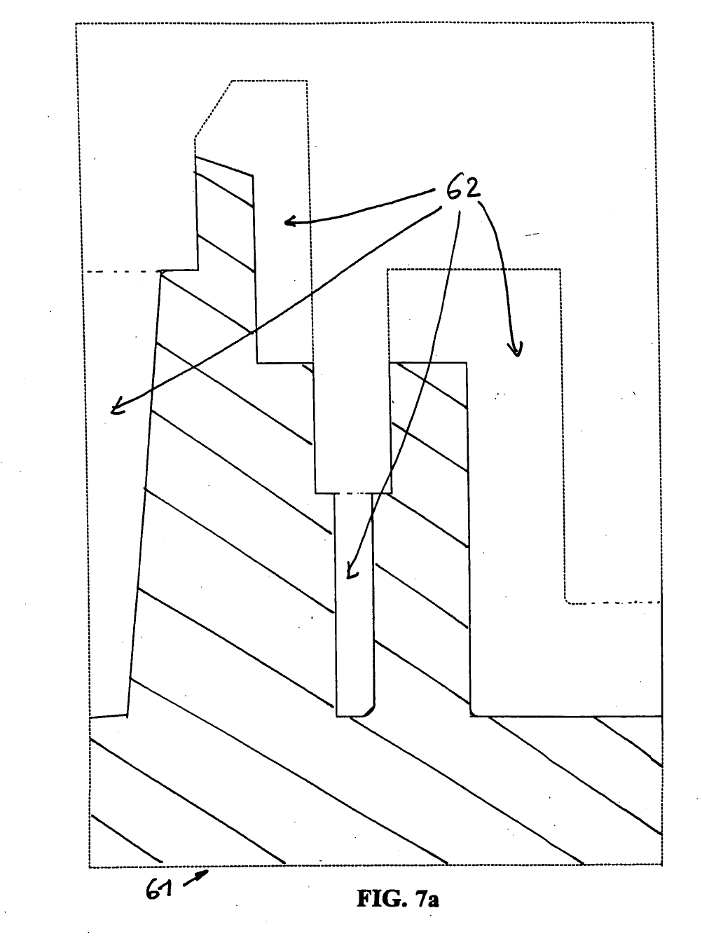

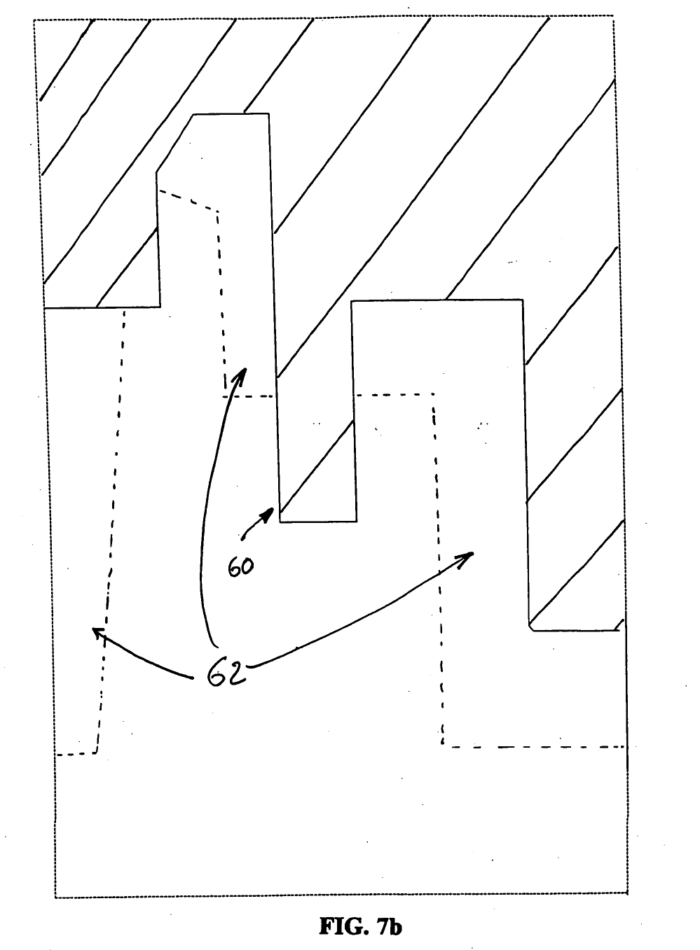

As illustrated in FIGS. 6 and 7a to 7b, all bottom elements (3) and particularly all elements forming the second closer element (31), namely for the cases according to FIGS. 5a to 5i, the said front piece (34), spacers (35) and the transverse tab (36) may be formed simply, each of these elements can be formed by cooperation of the upper part (60) and lower part (61) of a manufacturing mould (6), which opens and closes according to a simple single directional axial displacement.

As can be seen particularly in FIGS. 1d, 2b, 3 and 3a to 3f, 8 and 8a to 8f, 9 and 9a to 9f, it is clear that any part of the second closer element (31) according to the invention may be accessible from the top, from the bottom and from the sides, in other words delimited by a wall of the top part (60) or bottom part (61) of the mould (6), such that firstly the inner cavity (62) of the mould (6) corresponding to the part to be moulded is formed by a simple relative axial displacement of the said upper part (60) or lower part (61) of the mould (6), that considerably facilitates mould opening and closing operations, and secondly the moulded part can easily be extracted from the mould (6), the top part and the bottom part not including any concave or recessed lateral parts that could make it difficult to extract the said single piece part (7).

According to the invention, and as illustrated in FIG. 1c that shows material inlets (326), the said bottom (3) may include the said peripheral cavity (325) with an inverted “U” section, and in this case the said duct may open up inside the said peripheral cavity (325), and typically at the bottom of the said peripheral cavity, such that the said bottom (3) does not have any visible mark of the said moulding.

As illustrated in FIG. 1c, it is also possible to have material inlets (326) both in the said peripheral cavity (325) and on the inner surface of the said lower panel (33), at each of the four corners of the case.

### EXAMPLE EMBODIMENTS

Bottoms (3) were moulded either from SAN or PS, using a mould (6) in two parts (60, 61) with axial displacement as illustrated in FIGS. 7a and 7b.

Covers (2) made of PS were also moulded with a two-part mould with axial displacement.

The cases (1) were formed by axial click fitting, all these cases (1) including the same hinge (4). However, several embodiments of the closer (5) and particularly the second closer element (31) were made, differentiated by the said solidarisation means that forms or includes a springback means.

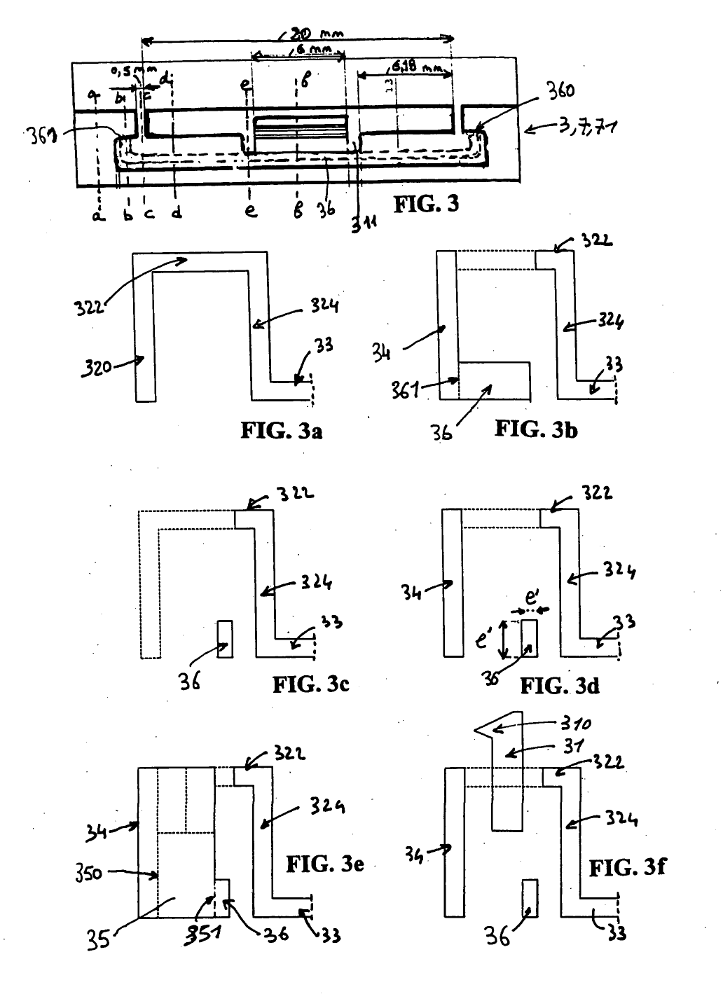

FIGS. 1a to 7b illustrate a first embodiment of the solidarisation means. According to this embodiment, as can be seen particularly in FIGS. 1d and 3, the said solidarisation means includes the transverse tab (36). In FIG. 3, the said transverse tab (36) has been shown in dashed lines. This tab (36) is in the form of a broadly flared “U” that comprises a straight part with a length L′ of 23.54 mm, curved towards the right and left at the right end (360) and the left end (361) forming the junction with the outer skirt (320) of the bottom (3).

FIGS. 8 and 8a to 8f illustrate a second embodiment of the solidarisation means. According to this embodiment, the said solidarisation means includes two spacers (35, 35′) located on each side of the central part of the said front part (34), the central part including two projections (311) that solidarise the locking lip (310) to the said front part (34). The dimensions of these spacers (35, 35′), and particularly the thickness Eₚ′, are chosen such that the said front part (34) can bend when a manual force is applied on its upper part (340′) introducing a separation, and then return to its original position as soon as the said force is released.

In FIG. 8, each of these spacers (35) and (35′) has been shown between two dashed lines.

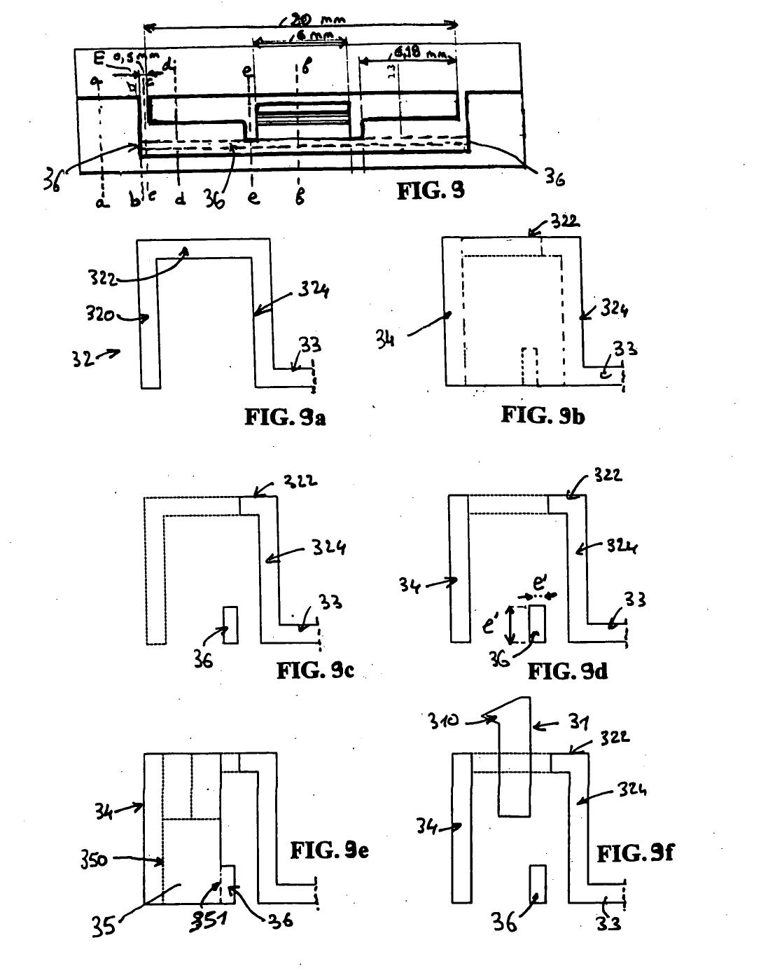

FIGS. 9 and 9a to 9f illustrate a third embodiment of the solidarisation means.

This embodiment is different from the first embodiment in that the said transverse tab (36) is straight, as illustrated in FIG. 9 in which the said transverse tab (36) has been shown in dashed lines.

### ADVANTAGES OF THE INVENTION

The invention can be used to make cases (1) economically because:
firstly, these cases (1) only include a very limited number of distinct parts moulded from a thermoplastic material, actually two parts, namely a bottom (3) and a cover (2),
secondly, these two parts (2, 3) may be assembled by simple click fitting, typically axial click fitting,
and finally these two parts (2,3) are designed such that they are simple and easy to mould and remove from the mould.

Thus, the invention can be used to make cases (1) in which the closer (5) and the hinge (4) do not require any distinct or complementary parts, at high speed, without reducing their technical quality.

It is also possible to use a relatively rigid thermoplastic material with good mechanical characteristics to form the said case (1), and typically the said bottom (3), such a material being advantageous particularly to obtain a case with a high quality surface condition.

List of Marks
Case . . . 1
Cover . . . 2
   First hinge element 4 . . . 20
   First closer element 5 . . . 21
   Locking hook . . . 210
Bottom . . . 3
Inner frame . . . 3′
   Second hinge element . . . 30
   Second closer element 5 . . . 31
   Locking lip . . . 310
   Projection solidarising 310 to 34 . . . 311
   Peripheral border . . . 32
      Outer skirt of 32 . . . 320
      Recessed external part of 33 . . . 321
      Plane upper edge of 32 . . . 322
      Recessed part of 322 . . . 323
      Inner skirt . . . 324
      Peripheral cavity . . . 325
      Material inlet . . . 326
   Lower panel . . . 33
   Front part . . . 34
      Upper edge . . . 340
      Upper part . . . 340′
      Lower edge . . . 341
      Lower part . . . 341′
   Spacer . . . 35
      Front junction . . . 350
      Rear junction . . . 351
   Transverse tab . . . 36
      Right end . . . 360
      Left end . . . 361
   Central cavity . . . 37
Hinge=20+30 . . . 4
   Rotation axis . . . 40
   Male element . . . 41
   Spindle . . . 41
   Female element . . . 42
   Hub . . . 42′
   Lateral opening . . . 420
   Facing wall elements . . . 421
   Click fit elements . . . 422
Closer (22+32) . . . 5
   Pushbutton . . . 50
Manufacturing mould . . . 6
   Upper part . . . 60
   Lower part . . . 61
   Inner cavity . . . 62
Moulded single piece part . . . 7
   Single piece cover provided with 20 and 21 . . . 70
   Single piece bottom or inner frame provided with 30 and 31 . . . 71

1. Case (1) designed for packaging of cosmetic products, comprising a cover (2) typically provided with a mirror, and with a first hinge element (20) and a bottom (3), possibly including an inner frame (3′) fixed to the said bottom (3), forming a central cavity (37) that contains the said cosmetic product or a receptacle containing the said cosmetic product, the said bottom (3) or the said inner frame (3′) being provided with a second hinge element (30), a hinge (4) being formed by cooperation between the said first (20) and second (30) hinge elements so as to enable the cover (2) to rotate with respect to the said bottom (3) about a rotation axis (40), a closer (5) or any means of locking and unlocking the said cover (2) with respect to the said bottom (3) or the said inner frame (3′), typically comprising cooperation of a first closer element (21), typically a locking hook (210) fixed to the said cover (2), and a second closer element (31) fixed to the said bottom (3) or the said inner frame (3′), and typically comprising a lip (310) that will cooperate with the said hook (210), the said closer (5) or the said second closer element (31) typically being activated by a push button (50), the said case (1) possibly including an applicator of the said cosmetic product, characterised in that:
a) the said bottom (3) includes a peripheral border (32) provided with a typically straight outer skirt (320), the said outer skirt (320) typically having a discontinuity on all or some of its height H and along a peripheral length L on its front part, so as to form a recessed outer part (321),
b) the said bottom (3) comprises a front part (34) fixed to the said lip (310), the said front part (34) being placed in the said recessed part (321) and separated from the said outer skirt (320) typically by two side axial recesses with spacing E typically less than 1 mm, so as to be free to move with respect to the said outer skirt (320),
c) the said front part (34) forms a single-piece part with the said bottom (3) or with the said inner frame (3′), due to a solidarisation means,
d) the said solidarisation means forms or includes a springback means, such that the said lip (310) fixed to the said front part (34) which is typically rigid, has a lateral displacement latitude, typically by translation and/or rotation, and thus allows reversible cooperation with the said hook (210), and that the said second closer element (31) forms a single piece part with the said bottom (3) or the said inner frame (3′), typically made of a thermoplastic material;
e) the said front part (34) has the said height H.

2. Case according to claim 1, in which the said lateral displacement of the said lip (310) is achieved by applying manual pressure on the said cover (2), the said bottom (3) being held fixed.

3. Case according to claim 1, in which the said lateral displacement of the said lip (310) is achieved by applying manual pressure on the said front part (34), acting as a push button (50).

4. Case according to claim 1, in which the said front part (34) is a rigid part, the said lip (310) typically also being rigid.

5. Case according to claim 1, in which the said front part (34) has an upper border (340) flush with the top surface of the said peripheral border (32).

6. Case according to claim 1, in which the said front part (34) has a vertical cross section typically similar to that of the said recessed outer part (321) so that it is inserted in the said recessed external part (321), and an external surface typically forming an extension of the said outer skirt (320) such that the shape and surface of the said front part (34) are continuous with the shape and surface of the said outer skirt (320).

7. Case according to claim 1, in which the said solidarisation means includes at least one spacer (35) fixed to the lower part (341′) of the said front part (34) through its front junction (350), and typically arranged to be perpendicular to the said front part (34), such that the said lateral displacement may typically include a rotation of the said front part (34) when the said manual pressure is applied on an upper part (340′) of the said front part (34).

8. Case according to claim 7, in which the said spacer (35) is fixed to the said bottom (3) or the said inner frame (3′) through its rear junction (351), the dimensions of the said spacer (35) being chosen to achieve the said rotation and the said springback.

9. Case according to claim 7, in which the said spacer (35) is solidarised, through its rear junction (351), to a transverse tab (36) typically parallel to the said front part (34), comprising ends (360, 361) fixed to the said bottom (3) or the said inner frame (3′), with dimensions and particularly length L′, width l′ and thickness e′ chosen so as to enable translation and/or rotation of the said front part (34) and the said springback, the said transverse tab (36) typically forming a torsion and/or bending tab.

10. Case according to claim 9, in which the length L′ is equal to at least the said length L, the said length L′ being the distance separating the said ends (360, 361).

11. Case according to claim 9, in which the width l′ typically varies from 1 to 3 mm, and in which the thickness e′ typically varies from 0.3 mm to 1.5 mm.

12. Case according to claim 9, in which the distance d between the said upper part (340′) of the said front part (34) and the said transverse tab (36) is such that the d/l′ ratio is equal to at least 1 and preferably at least 1.5.

13. Case according to claim 9, in which the said front part (34) is fixed to the said bottom (3), the said front part (34) and the said bottom forming the said single piece part (7,71).

14. Case according to claim 13, in which the said peripheral border (32) of the bottom (3) includes a typically plane upper edge (322) fixed to the said outer skirt (320), the said upper edge (322) comprising a recessed part (323), so as in particular to displace the said front part (34) and to displace the said locking lip (310) in order to open the case, the said front part (34) being aligned on the outside, with the said peripheral border (32) and more precisely with the said outer skirt (320) and with the said upper edge (322).

15. Case according to claim 14, in which the said peripheral border (32) may comprise an inner skirt (324) fixed to the said plane upper edge (322), the said outer skirt (320), the said plane upper edge (322) and the said inner skirt (324) forming a peripheral cavity (325) with an inverted “U” profile on all or some of the case, typically on the sides and on a front part of the case.

16. Case according to claim 15, in which the said bottom (3) comprises a lower panel (33) fixed to the said inner skirt (324) so as to form the said central cavity (37) in the case in which the said bottom (3) is not provided with an inner frame (3′), the said central cavity (37) having a depth H−Ep, where Ep is the thickness of the said lower panel (33).

17. Case according to claim 1, in which the said hinge (4) is formed by cooperation of at least one male element (41) with at least one female element (42), the said female element (42) forming a hub with a lateral axial opening with springback (420), such that the said hinge (4) is formed by click fitting of the said male element (41) and female element (42).

18. Case according to claim 17, in which the said female element (42) comprises two wall elements facing each other and parallel to each other (421) that may be moved elastically apart during the said click fitting, and with an axial recess forming the said hub.

19. Case according to claim 17, in which the said first hinge element (20) carried by the said cover (2) includes the said female element (42), the said second hinge element (30) carried by the said bottom (3) including the said male element (41).

20. Case according to claim 17, in which the said second hinge element (30) carried by the said bottom (3) includes the said female element (42), the said first hinge element (20) carried by the said cover (2) then including the said male element (41).

21. Case according to claim 17, in which the said female element (42) forms or includes one or two hubs M1, M2 (42′), the said male element (41) forming or including one or two spindles E1, E2 (41′), the said hinge (4) comprising a central hinge or two half-hinges, a right half-hinge, and a left half-hinge, each half-hinge being formed by cooperation of a hub M1, M2 (42′) and a corresponding spindle E1, E2 (41′).

22. Case according to claim 21, in which the said female element (42) forms or includes two distinct hubs M1 and M2 (42′), the said male element (41) forming or comprising one or two distinct spindles E1 and E2 (41′), the two hubs M1 and M2 forming the outside of the said hinge (4) and the two spindles E1 and E2 forming the inside of the said hinge (4), the said hinge (4) then forming a sequence denoted “M1-E1-E2-M2”.

23. Case according to claim 21, in which the said female element (42) forms or includes two distinct hubs M1 and M2 (42′), the said male element (41) forming or comprising one or two distinct spindles E1 and E2 (41′), the two hubs M1 and M2 forming the inside of the said hinge (4) and the two spindles E1 and E2 forming the outside of the said hinge (4), the said hinge (4) then forming a sequence denoted “E1-M1-M2-E2”

24. Case according to claim 1, in which the said hinge (4) is formed by click fitting typically in the axial direction, of the said first (20) and second (30) hinge elements, the said bottom (3) typically without the said inner frame (3′) forming the said central cavity (37).

25. Case according to claim 1, in which the said thermoplastic material forming the said cover (2) is a typically transparent thermoplastic material, the said bottom (3) being formed from a transparent thermoplastic material or a non-transparent plastic material, containing a typically pigmented colouring material.

26. Case according to claim 1, in which the said thermoplastic moulded part forming the said moulded single piece part (7) is made of a so-called “rigid” thermoplastic material with a bending modulus equal to at least 2000 MPa, typically chosen from among SAN or PS.

27. Case according to claim 1, in which the said front part (34) forming part of the said closer (5) is straight or curved, depending on the shape of the said case that may be polygonal and typically square or rectangular, or round, or oval.

28. Manufacturing method for a case according to claim 1, in which the said bottom (3) and/or the said cover (2) are formed by moulding a thermoplastic material in a mould (6) typically in two parts, an upper part (60) and a lower part (61) that cooperate by axial displacement to form an inner cavity (62) corresponding to the said bottom (3) or the said cover (2) and supplied with thermoplastic material through at least one duct, all parts of the said cavity and therefore all parts of the said bottom or the said cover possibly being formed or delimited by one or several axial elements (600, 610) of the said upper part (6) and/or the said lower part (61), such that the said mould (6) can be closed and then opened by a simple single relative directional axial displacement of the said upper part (60) and lower part (61) and/or the said corresponding axial elements (600, 610), and that the said bottom (3) or the said cover (2) can then be extracted from the said open mould.

29. Method according to claim 28 in which the said bottom (3) includes the said peripheral cavity (325) with an inverted “U” section, and in this case the said duct opens up inside the said peripheral cavity (325), and typically at the bottom of the said peripheral cavity, such that the said bottom (3) does not have any visible mark of the said moulding.
